(19) United States
(12) Patent Application Publication
(10) Pub. No.: US 2013/0166379 A1
(43) Pub. Date: Jun. 27, 2013

(54) Social Targeting

(71) Applicants: Akintunde Ehindero, Atlanta, GA (US); Rajiv Narang, Austin, TX (US); Yingchi Chen, Austin, TX (US)

(72) Inventors: Akintunde Ehindero, Atlanta, GA (US); Rajiv Narang, Austin, TX (US); Yingchi Chen, Austin, TX (US)

(21) Appl. No.: 13/455,497

(22) Filed: Apr. 25, 2012

Related U.S. Application Data
(60) Provisional application No. 61/578,607, filed on Dec. 21, 2011.

(51) Int. Cl. G06Q 30/00

(52) U.S. Cl. 705/14.52; 705/14.49

(57) ABSTRACT

A system and method are disclosed for social targeting within a social media environment. A sample set of social media interactions containing a reference to an intent to purchase a product is processed to generate a prioritization index. The prioritization index is then used to monitor social media interactions in a target social media environment to identify social media users exhibiting propensity-to-purchase behavior. A propensity-to-purchase value is then generated for each of the identified social media users and they are ranked accordingly. The ranked social media users are then converted into sales leads for nurturing.

### CROSS-REFERENCE TO RELATED APPLICATION

This application claims the benefit under 35 U.S.C. §119(e) of U.S. Provisional Application No. 61/578,607, filed Dec. 21, 2011, entitled “Social Targeting.” U.S. Provisional Application No. 61/578,607 includes exemplary systems and methods and is incorporated by reference in its entirety.

### BACKGROUND OF THE INVENTION

1. Field of the Invention

Embodiments of the invention relate generally to information handling systems. More specifically, embodiments of the invention provide a system and method for social targeting within a social media environment.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

In recent years, information handling systems have also been instrumental in the widespread adoption of social media into the mainstream of everyday life. Social media commonly refers to the use of web-based technologies for the creation and exchange of user-generated content for social interaction. As such, it currently accounts for approximately 22% of all time spent on the Internet. More recently, various aspects of social media have become an increasingly popular for enabling customer feedback, and by extension, have likewise evolved into a viable marketing channel for vendors. This new marketing channel, sometimes referred to as “social marketing,” has proven to not only have a higher customer retention rate than traditional marketing channels, but to also provide higher demand generation “lift.”

Other aspects of social marketing include campaign management, which allows organizations and marketers to target populations of social media users that exhibit the same, or similar, set of characteristics. Interactions with individuals within these segments are then specified to increase the likelihood of a positive outcome, such as making a purchase. Such interactions may be a single point of contact or a series of contacts across one or more mediums over a period of time.

While social marketing campaigns may define the ‘how, when, and where’ to communicate to a social media user, they do not identify with any degree of specificity which of these users could be prospective customers. Currently, vendors and marketers rely upon online signup forms to identify sales leads. These forms often require prospective customers to explicitly indicate an interest in a product or service. Accordingly, it would be desirable to provide a means for generating sales leads and enabling social targeting via a customer's social and online activity on internal supplier websites as well as external websites.

### SUMMARY OF THE INVENTION

A system and method are disclosed for social targeting within a social media environment. In various embodiments, a social targeting system is implemented to identify social media users that exhibit an intent to purchase a product or solution by analyzing their social footprint, online behavior, past purchase activity, and other interactions with a target vendor.

In these and other embodiments, a sample set of social media interactions containing a reference to an intent to purchase a product is processed to generate a prioritization index. The prioritization index is then used to monitor social media interactions in a target social media environment to identify social media users exhibiting propensity-to-purchase behavior. A propensity-to-purchase value is then generated for each of the identified social media users and they are ranked accordingly. The ranked social media users are then converted into sales leads for nurturing. In one embodiment, the sales leads are processed to identify net new sales leads. In another embodiment, the sales leads are processed to identify current sales leads for various products are services, which are in turn ranked accordingly.

In one embodiment, Natural Language Processing (NLP) operations are performed to identify the sample set of social media interactions. In another embodiment, the prioritization index is generated from a site visit index and a purchase index. In yet another embodiment, the propensity-to-purchase value is generated by performing statistical modeling operations. In still another embodiment, the statistical modeling operations are performed using a set of media response variables, a set of revenue variables, a set of promotion variables, a set of firmographics data, and at least one site visit index as input data.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 is a generalized illustration of the components of an information handling system as implemented in the system and method of the present invention;

FIG. 2 shows a block diagram of a social targeting system;

FIG. 3 shows a block diagram of the generation of a propensity-to-purchase score;

FIG. 4 shows the correlation between advertising, social visit patterns, and purchase patterns for a plurality of companies as displayed within a user interface window;

FIG. 5 shows a block diagram of a prioritization index comprising a purchase index and a visit index;

FIG. 6 shows example test results of a social targeting system as displayed within a user interface window;

FIG. 7 shows a user hub of a social targeting lead generation system as implemented within a user interface window;

FIG. 8 shows an example of lead conversion and campaign effectiveness of a social targeting system as displayed within a user interface window;

FIG. 9 is a generalized flowchart of the performance of Natural Language Processing (NLP) operations; and

FIG. 10 is a generalized flowchart of the performance of behavioral analysis operations.

### DETAILED DESCRIPTION

A system and method is disclosed for social targeting within a social media environment. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

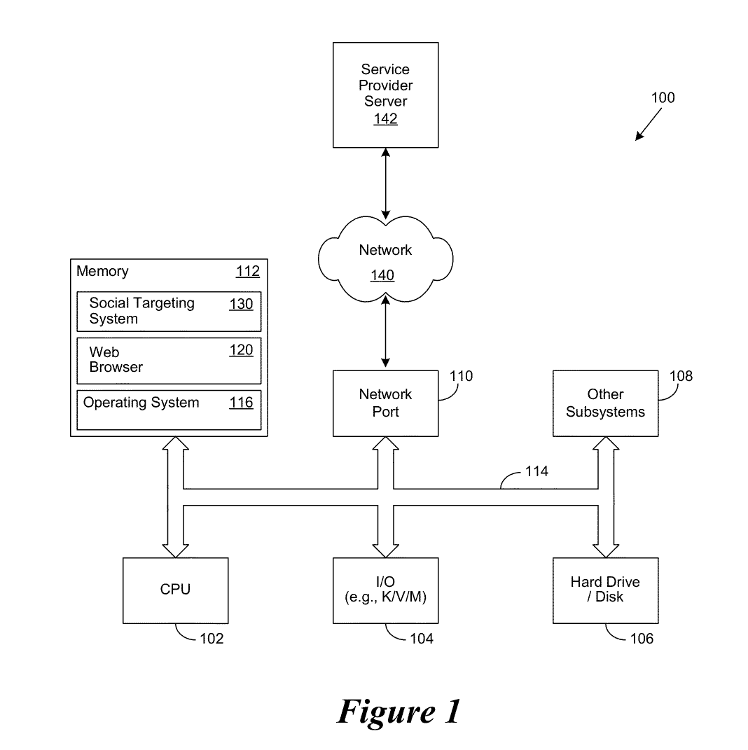

FIG. 1 is a generalized illustration of an information handling system 100 that can be used to implement the system and method of the present invention. The information handling system 100 includes a processor (e.g., central processor unit or “CPU”) 102, input/output (I/O) devices 104, such as a display, a keyboard, a mouse, and associated controllers, a hard drive or disk storage 106, and various other subsystems 108. In various embodiments, the information handling system 100 also includes network port 110 operable to connect to a network 140, which is likewise accessible by a service provider server 142. The information handling system 100 likewise includes system memory 112, which is interconnected to the foregoing via one or more buses 114. System memory 112 further comprises operating system (OS) 116 and a Web browser 120. In various embodiments, the system memory 112 may also comprise a social targeting system 130. In one embodiment, the information handling system 100 is able to download the Web browser 120 and the social targeting system 130 from the service provider server 142. In another embodiment, the social targeting system 130 is provided as a service from the service provider server 142.

In various embodiments, the social targeting system 120 is used to identify social media users that exhibit an intent to purchase a product or solution by analyzing their social footprint, online behavior, past purchase activity, and other interactions with a target vendor. For example, a customer may not have purchased a server-type information handling system in a certain amount of time (e.g., 20 months), thereby indicating a purchase history. However, the same customer may have been researching server-type information handling systems in an online community for another certain amount of time (e.g., a few weeks), thereby indicating their intent to purchase. As a result, the customer can be identified as a high priority account with an intent to purchase server-type information handling systems in the near future. This information is then provided to a sales organization as a potential sales lead.

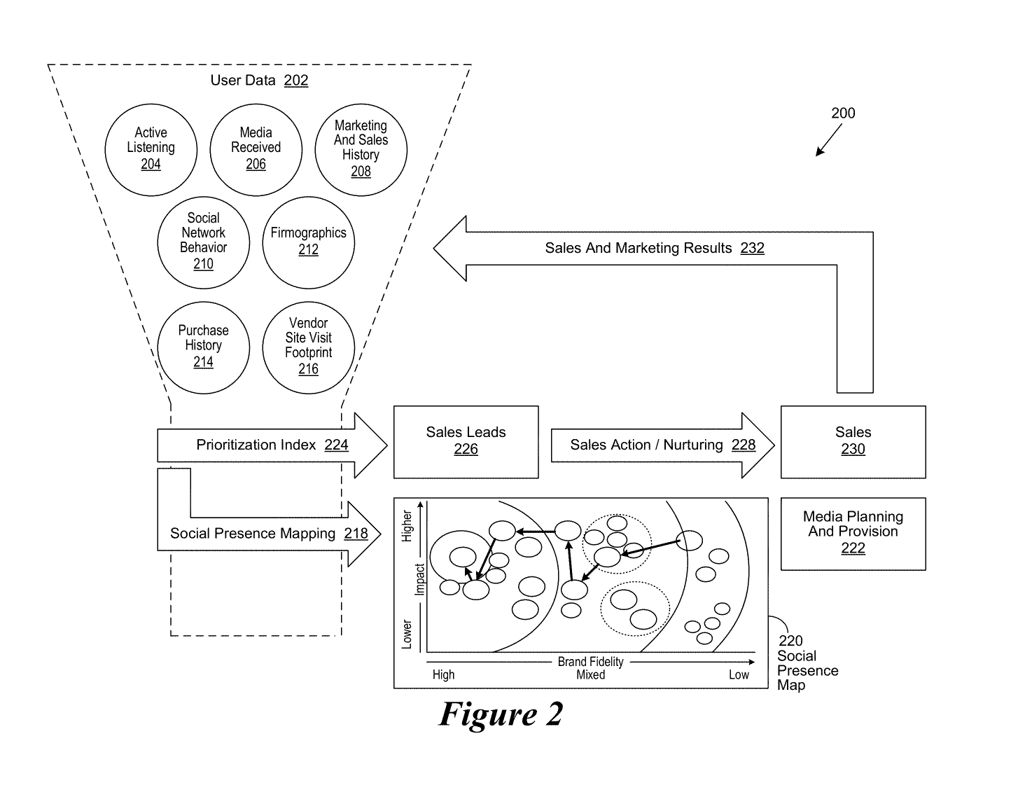

FIG. 2 shows a block diagram of a social targeting system as implemented in accordance with an embodiment of the invention. As used herein, social targeting broadly refers to the identification of potential sales targets through analysis of a user's social behavior within a social media environment. In various embodiments, social targeting is implemented by the social targeting system 200 to identify correlations between a user's consumption of social content, their social media interactions, and their subsequent purchase behavior. In these and other embodiments, these correlations are used to create a mathematical model that predicts a user's likelihood, or propensity, to purchase a target product or service.

Referring now to FIG. 2, user data 202 comprises active listening 204 data, media received 206 data, marketing and sales history 208 data, social network behavior 210 data, firmographics 212 data, purchase history 214 data, and vendor site visit 216 data. As used herein, active listening 204 data refers to data that is collected by actively monitoring social media interactions between users of a social media environment, and media received 206 data broadly refers to data related to any media received by a user of a social media environment. As likewise used herein, marketing and sales history 208 data refers to data related to marketing efforts (e.g., campaigns, promotions, advertising, etc.) and resulting sales associated with one or more users of a social media environment. Likewise, as used herein, social network behavior 210 data broadly refers to data related to social media interactions performed by a user of a social media environment. Firmographics 212 data, as used herein, refers to data related to the characteristics (e.g., industry, revenue, number of employees, etc.) of an organization. As used herein, purchase history 214 data refers to data related to past purchases of goods and services by one or more users of a social media environment. As likewise used herein, vendor site visit footprint 216 data broadly refers to data related to visits made to a vendor's site by one or more users of a social media environment.

In various embodiments, the user data 202 is processed to generate a prioritization index 224 and to perform social presence mapping 218 operations. As described in greater detail herein, the prioritization index is used to generate sales leads 226, which in turn are used in sales action and nurturing 228 operations to generate sales 230. Likewise, the social presence mapping 218 operations are performed to generate social presence maps 220, which are in turn used for media planning and provision 222 operations. In these and other embodiments, the sales 230 and media planning and provision 222 operations result in sales and marketing results 232, which provide additional input to user data 202.

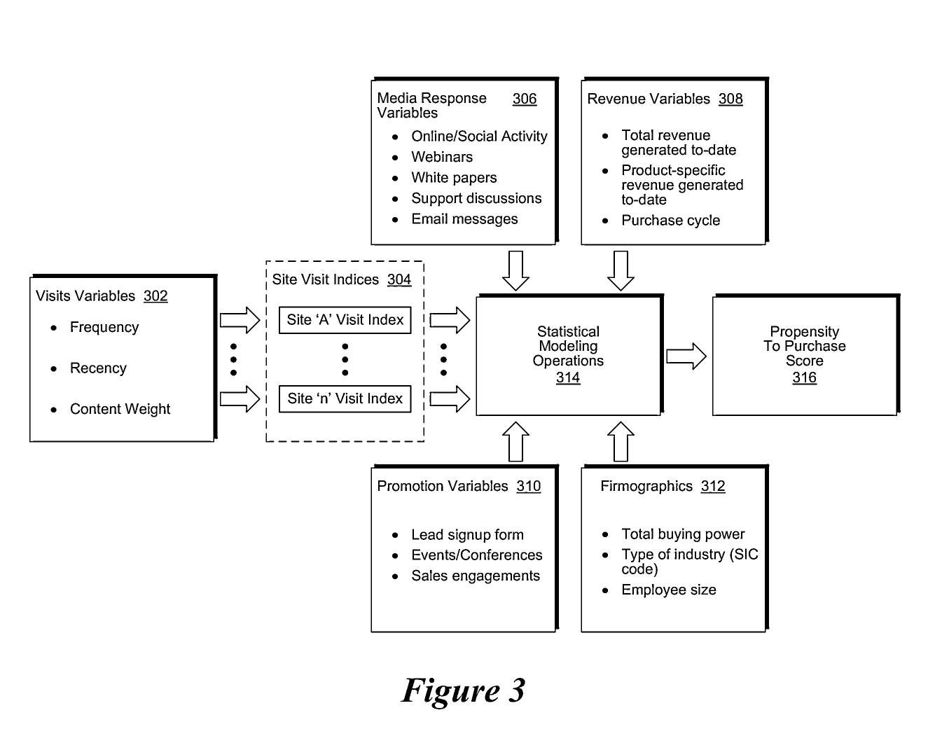

FIG. 3 shows a block diagram of the generation of a propensity-to-purchase score as implemented in accordance with an embodiment of the invention. In various embodiments, a propensity-to-purchase score 316 is generated for predetermined social media users and they are ranked accordingly. The ranked social media users are then converted into sales leads for nurturing. In one embodiment, the sales leads are processed to identify net new sales leads. In another embodiment, the sales leads are processed to identify current sales leads for various products are services, which are in turn ranked accordingly.

In certain embodiments, the propensity to purchase score is generated by performing statistical modeling operation 314 familiar to skilled practitioners of the art. In these and other embodiments, media response variables 306, revenue variables 308, promotion variables 310, firmographics 312, and site visit indices 304, described in greater detail herein, are used as inputs when performing the statistical modeling operations 314. As shown in FIG. 3, media response variables 306 may comprise responses to the interaction with a variety of media, such as social and online activity, webinars, white papers, support discussions, email messages, and so forth. Likewise, revenue variables 308 may comprise the total and product-specific revenue generated to-date by one or more users of a social media environment, as well as the purchase cycle. As likewise shown in FIG. 3, promotion variables 310 may comprise information generated from interaction with one or more lead signup forms, events or conferences, sales engagements, and so forth. Likewise, firmographics 312 may comprise characteristics (e.g., industry, revenue, number of employees, etc.) of an organization associated with a user of a social media environment. Likewise, site visit indices 304 may comprise indices associated with one or more sites visited by a user of a social media environment. In various embodiments, the site visit indices 304 are generated using visits variables 302, which may include the frequency and recency of visits made by a user of a social media environment, as well as a social content weighting score, which references the relevance of the social content to the visits.

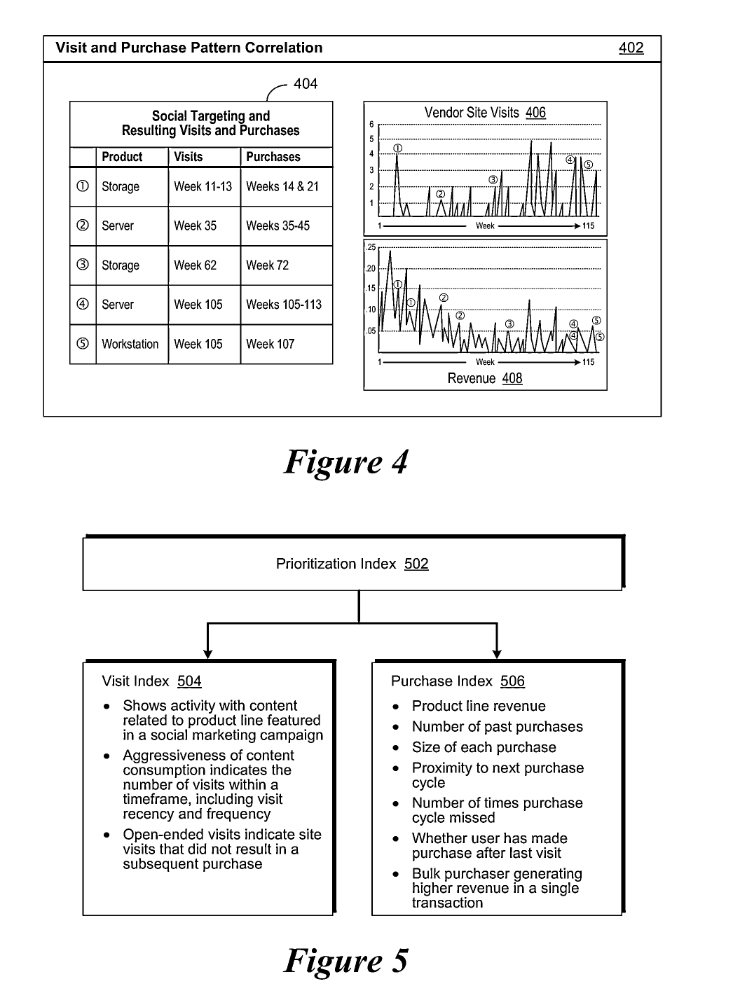

FIG. 4 shows the correlation between advertising, social visit patterns, and purchase patterns for a plurality of companies as displayed in accordance with an embodiment of the invention within a user interface window. In various embodiments, users of a social media environment are incented to visit a vendor's site through the receipt of targeted social marketing content. The correlation between the receipt of the targeted social media marketing content and resulting visits and purchase patterns can then be determined.

In this embodiment, the correlation is displayed within a “Visit and Purchase Patterns Correlation” 402 user interface (UI) window. As shown in FIG. 4, the “Visit and Purchase Patterns Correlation” 402 UI window comprises a “Social Targeting and Resulting Visits and Purchases” 404 table, which shows the timing correlation between the provision of product-specific social marketing content to targeted social media users and their subsequent vendor site visits and purchases. As likewise shown in FIG. 4, the “Visit and Purchase Patterns Correlation” 402 window also comprises a “Vendor Site Visits” 406 graph, showing site visit traffic, and a “Revenue” 408 graph, which shows the corresponding sales for each product resulting from the visits. In this and other embodiments, the correlation between the provision of social marketing content and the subsequent site visits and purchases are illustrated through the implementation of numeric icons within “Social Targeting and Resulting Visits and Purchases” 404 table, “Vendor Site Visits” 406 graph, and the “Revenue” 408 graph.

FIG. 5 shows a block diagram of a prioritization index comprising a purchase index and a visit index as implemented in accordance with an embodiment of the invention. In various embodiments, a “Prioritization Index” 502 is generated from a “Visit Index” 504 and a “Purchase Index” 506. In these and other embodiments, the “Visit Index 504 indicates a social media user's activity with content related to a product line featured in a social marketing campaign. The “Visit Index” 504 also indicates the aggressiveness of the consumption of the social marketing content by the user, which in turn indicates the number of site visits made by the user, within a predetermined timeframe, along with the recency and frequency of the visits. Likewise, the “Visit Index” 504 indicates the proportion of open-ended site visits that did not result in a subsequent purchase.

In certain embodiments, the “Visit Index” 504 is determined as follows:

Visit Index=Σ(MV*W_{website)}

where: Momentum of Visit (MV)=ΣVisits*Recency

where: Visits=Number of Visits

Recency=Recency of the Visit[1/(gap between the visit week and the last week considered in the visit window)]

W_{WEBSITE}=Weight for the website

where: W_{A}=1, W_{B}=1, W_{VENDOR}=0.5

In various embodiments, the “Purchase Index” 506 indicates the product line revenue, the number of purchases, and the size of each purchase made by the social media user. The “Purchase Index” 506 likewise indicates the proximity to the social media user's next purchase cycle, the number of times that the purchase cycle has been missed, whether a purchase has been made since the last visit, and whether the user is a bulk purchaser.

In certain embodiments, the “Purchase Index” 506 is determined as follows:

$$Purchase Index = R * P V * S O W$$

$$where \text{:}$$

$$Magnitude of Vendor Revenue ( R ) = Revenue generated in the past$$

$$\begin{matrix}P V = Closeness to realizing a Purchase \\ = \frac{( \frac{C W - L P W}{P C } ) - Integer ( \frac{C W - L P W}{P C} )}{Integer ( \frac{C W - L P W}{P C} ) + 1}\end{matrix}$$

$$where \text{:}$$

$$C W = Current Week$$

$$L P W = Last Purchase Week$$

$$P C = Purchase Cycle ( average of the differences between consecutive purchases madeLast Purchase Week S O W = Share of Wallet$$

Likewise, the “Prioritization Index” 502 is determined in certain embodiments as follows:

Prioritization Index=(w₁)Visit Index+(w₂)Purchase Index

where: w₁=2 and w₂=1

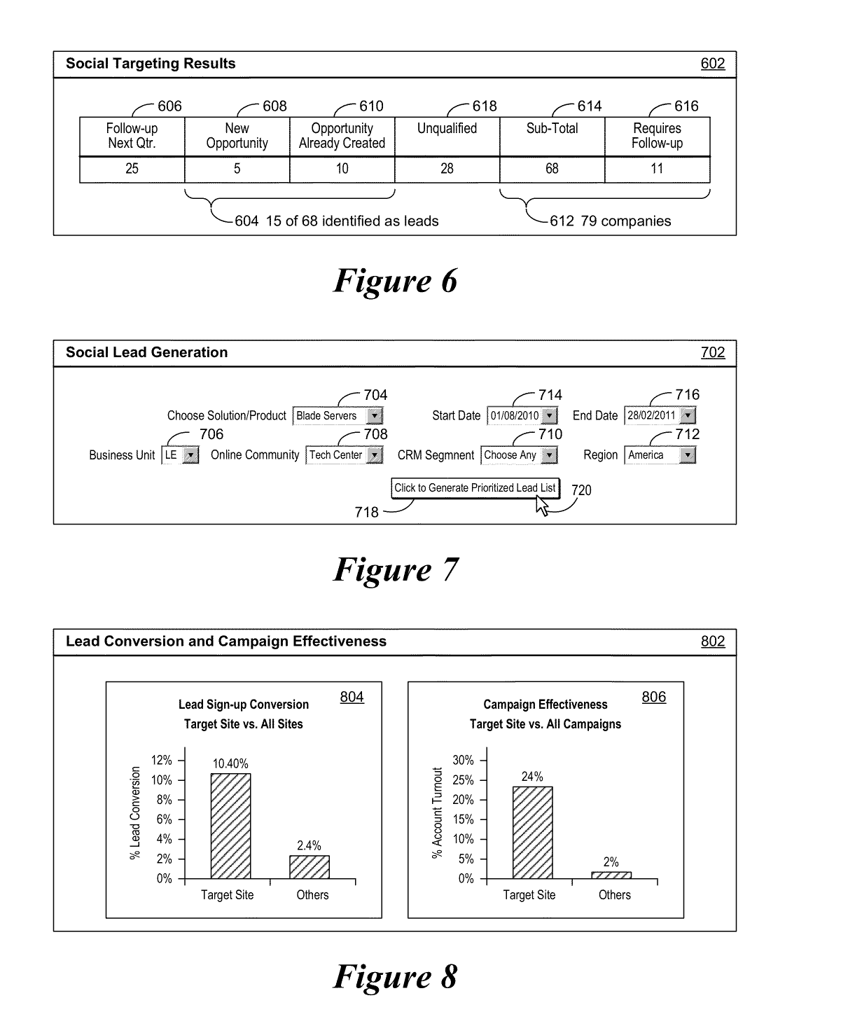

FIG. 6 shows example test results of a social targeting system as displayed in accordance with an embodiment of the invention within a user interface window. In this embodiment, example test results of a social targeting system are displayed within a “Social Targeting Results” 602 window. As shown in FIG. 6, the “Social Targeting Results” 602 user interface (UI) window comprises a variety of social targeting information, including the number of sales targets to “Follow-up Next Quarter” 508. The “Social Targeting Results” 602 UI window also comprises the number of sales targets that are a “New Opportunity” 608, the number of sales targets that represent an “Opportunity Already Created” 610 and the number of sales targets that are “Unqualified” 618. Likewise, the “Social Targeting Results” 602 window comprises the total number of identified leads 604. As also shown in FIG. 6, the “Social Targeting Results” 602 UI window likewise comprises a variety of information related to the companies 612 associated with the sales targets, including a “Sub-Total” 614 number and the number requiring “Follow-Up” 616.

FIG. 7 shows a user hub of a social targeting lead generation system as implemented in accordance with an embodiment of the invention within a user interface window. In this embodiment, a “Social Lead Generation” 702 user interface window comprises a plurality of drop-down menus 704, 706, 708, 710, 712, 714, 716, which allow a user to select various lead generation parameters. Once the parameter selections are made, the user selects the “Click to Generate Prioritized Lead List” 718 command button through a user gesture, such as a mouse-click with cursor 720, which results in the generation of a prioritized lead list as described in greater detail herein.

FIG. 8 shows an example of lead conversion and campaign effectiveness of a social targeting system as displayed within a user interface window in accordance with an embodiment of the invention. In this embodiment, a “Lead Conversion and Campaign Effectiveness” 802 user interface window comprises “Lead Sign-up Conversion” 804 sub-window and a “Campaign Effectiveness” 806 sub-window. As shown in FIG. 8, the comprises “Lead Sign-up Conversion” 804 sub-window shows the percentage of sales leads conversions at a target site versus other sites, while the “Campaign Effectiveness” 806 sub-window shows the percentage of account turn-out at a target site versus other sites.

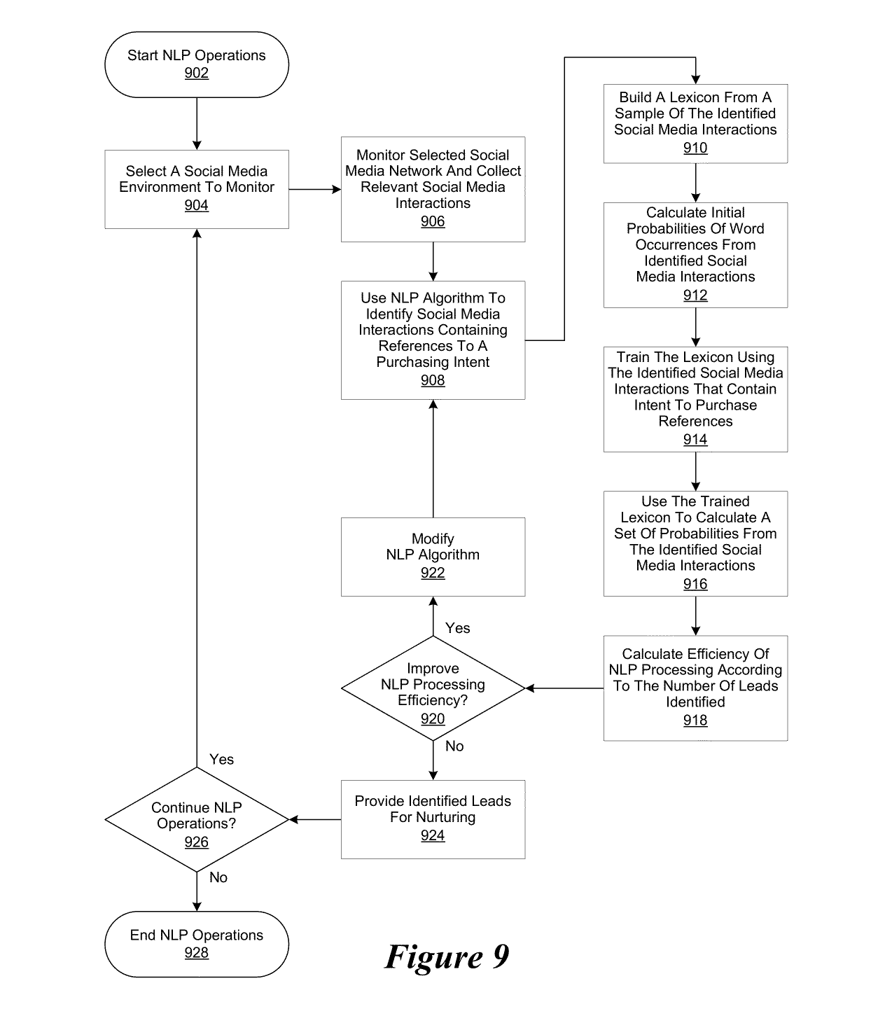

FIG. 9 is a generalized flowchart of the performance of Natural Language Processing (NLP) operations as implemented in accordance with an embodiment of the invention. In this embodiment, NLP operations are begun in step 902. As used herein, NLP refers to the field of computer science, artificial intelligence (AI), and linguistics concerned with the interactions between computers and human (natural) languages. More specifically, it refers to the process of a computing device, or other information handling system, extracting meaningful information from natural language input and then producing natural language output therefrom.

A social media environment is then selected in step 904 to monitor, followed by the collection in step 906 of relevant social media interactions performed within the selected social media environment. A NLP algorithm familiar to those of skill in the art is then used in step 908 to identify social media interactions containing references to a purchasing intent. As an example, a user may post a blog entry stating their intent to purchase a new server and likewise requesting input from subject matter experts to make recommendations on which server they would purchase.

A lexicon is then built in step 910 from a sample of the identified social media interactions. As used herein, a lexicon refers to a list of words and phrases that can be used in sentences. In various embodiments, each social media interaction is broken down into single, pairs and triads of words and their respective occurrence within the sample of identified social media interactions is counted. In certain embodiments, the lexicon is used in the NLP operations to identify and document lexemes, or word forms, that are used in a social media interaction. In various embodiments, the lexicon is used in the NLP operations to identify and document new and relevant lexemes, or neogolisms, that are used in the social media interactions.

Then, in step 912, the unigram, bigram and trigram probabilities are calculated based upon these occurrences. Once the probabilities are calculated in step 912, the lexicon is trained in step 914, using the identified social media interactions that contain “intent to purchase” references. In various embodiments, the single, pairs and triads word counts are increased ‘x’ times, based upon the size of the “intent to purchase” dataset. The resulting dataset is then merged with the original lexicon.

In these and other embodiments, the various social media interactions within the selected social media network are filtered to identify those interactions pertaining to the vendor or to the vendor's products and services. The remaining social media interactions are then further filtered to remove spam (e.g., non-vendor-related advertisements, emails, etc.). Once filtered, the social media interactions are then categorized and their respective sentiment is assessed using NLP processes familiar to those of skill in the art. As used herein, sentiment refers to the positive, neutral or negative tone of a portion of text. In one embodiment, sentiment assessment operations are performed to calculate a Social Net Advocacy Pulse (SNAP) metric, which is a measure of the sentiment and advocacy for each dimension of the vendor's business, based upon the underlying social media interactions.

In one embodiment, the social media interaction comprises a Twitter® message or Tweet, which in turn comprises one or more neogolisms. In this and other embodiments, the tweet comprises a sequence of words:

Tweet₁=w₁ w₂ w₃ w₄ w₅ . . . wₙ, where w₁=word₁

The trained lexicon is then used in step 916 to calculate a set of probabilities from the previously identified social media interactions contain references to an intent to purchase. Then, in step 918, the model's efficiency is calculated as the number of social media interactions it is able to identify as compared to the total number of “intent” social media interactions present in the dataset.

A determination is then made in step 920 whether to improve the efficiency of the NLP processing. If so, then the NLP algorithm is modified in step 922 by iterating the value of ‘x’ is to achieve the most efficient model, and the process is continued, proceeding with step 908. Otherwise, leads are provided for nurturing in step 924, followed by a determination in step 926 whether to continue NLP operations. If so, then the process is continued, proceeding with step 904. Otherwise NLP processing operations are ended in step 928.

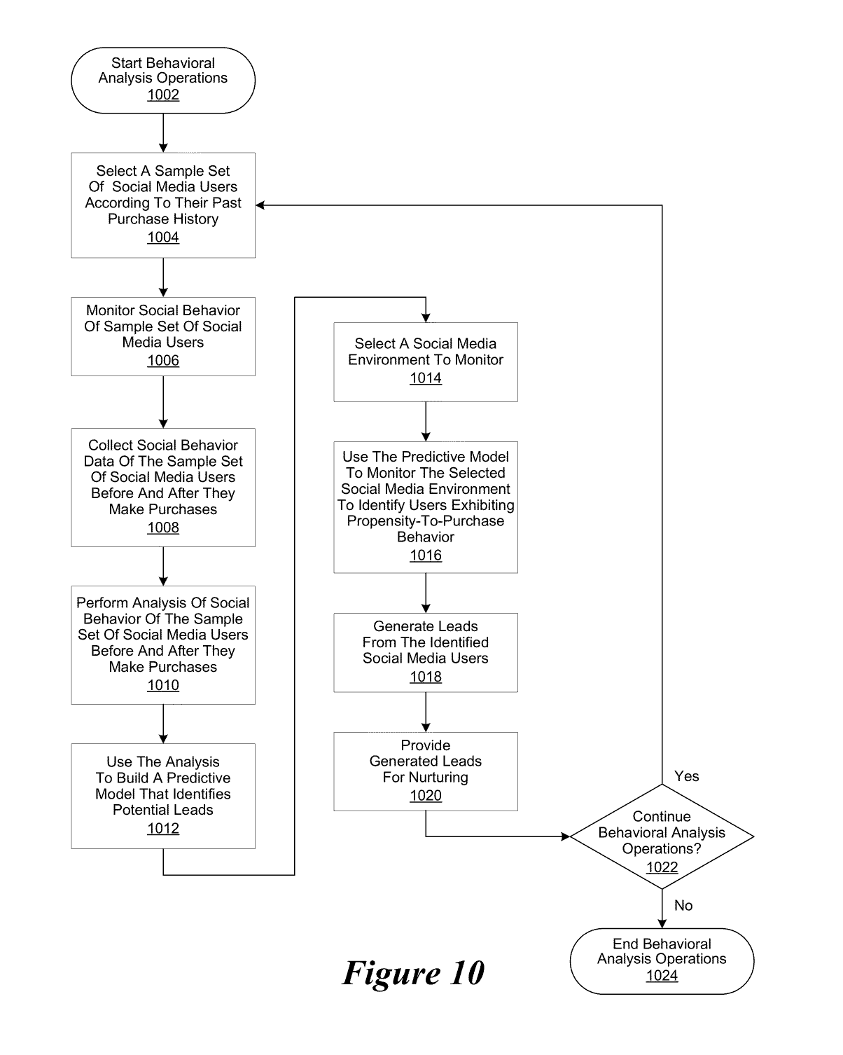

FIG. 10 is a generalized flowchart of the performance of behavioral analysis operations as implemented in accordance with an embodiment of the invention. In various embodiments, behavioral analysis operations are performed to identify social media users that have are likely, or have a propensity, to purchase a target product or service. In these and other embodiments, the behavioral analysis comprises observation and analysis of a user's social behavior within a social media environment and their past purchase history. In one embodiment, the behavioral analysis results in the generation of heuristics-based additive model for prioritizing target accounts or sales leads. In this and other embodiments, the heuristics-based additive model results in a Final Index, described in greater detail herein, which in turn comprises a Visit Index and a Purchase Index, likewise described in greater detail herein. In these various embodiments, the higher the Final Index score, the higher the likelihood of a target prospect making a purchase. In one embodiment, the sales leads are processed to identify net new sales leads. In another embodiment, the sales leads are processed to identify current sales leads for various products are services, which are in turn ranked accordingly.

In this embodiment, behavioral analysis operations are begun in step 1002, followed by the selection in step 1004 of a sample set of social media users according to their past purchase history. The social behavior of the sample set of social media users is then monitored in step 1006, followed by collecting the social behavior of the sample set of social media users in step 1008 before and after they make purchases. An analysis of the collected social behavior is then performed in step 1010, followed by using the analysis in step 1012 to build a predictive model that identifies potential sales leads.

A target social media environment is then selected in step 1014, followed by using the predictive model in step 1016 to monitor the selected social media environment to identify social media users exhibiting propensity-to-purchase behavior. Sales leads are then generated from the identified social media users in step 1018, followed by providing the leads for nurturing in step 1020. A determination is then made in step 1022 whether to continue behavioral analysis operations. If so, then the process is continued, proceeding with step 1004. Otherwise behavioral analysis operations are ended in step 1024.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

For example, the above-discussed embodiments include software modules that perform certain tasks. The software modules discussed herein may include script, batch, or other executable files. The software modules may be stored on a machine-readable or computer-readable storage medium such as a disk drive. Storage devices used for storing software modules in accordance with an embodiment of the invention may be magnetic floppy disks, hard disks, or optical discs such as CD-ROMs or CD-Rs, for example. A storage device used for storing firmware or hardware modules in accordance with an embodiment of the invention may also include a semiconductor-based memory, which may be permanently, removably or remotely coupled to a microprocessor/memory system. Thus, the modules may be stored within a computer system memory to configure the computer system to perform the functions of the module. Other new and various types of computer-readable storage media may be used to store the modules discussed herein. Additionally, those skilled in the art will recognize that the separation of functionality into modules is for illustrative purposes. Alternative embodiments may merge the functionality of multiple modules into a single module or may impose an alternate decomposition of functionality of modules. For example, a software module for calling sub-modules may be decomposed so that each sub-module performs its function and passes control directly to another sub-module.

Consequently, the invention is intended to be limited only by the spirit and scope of the appended claims, giving full cognizance to equivalents in all respects.

What is claimed is:

1. A computer-implemented method for social targeting, comprising:
processing a first set of social media interaction data to generate a second set of social media interaction data containing a reference to an intent to purchase a product, the first set of social media interaction data associated with a first set of social media users and the second set of social media interaction data associated with a second set of set of social media users;
processing the second set of social media interaction data to generate a prioritization index;
processing a third set of social media interaction data with the prioritization index to generate a propensity-to-purchase value for individual users of a third set of social media users, the third set of social media interaction data associated with the third set of social media users; and
performing ranking operations to rank the third set of social media users according to their respective propensity-to-purchase value.

2. The method of claim 1, wherein the second set of social media interaction data is generated by performing Natural Language Processing (NLP) operations.

3. The method of claim 1, wherein the prioritization index is generated from a site visit index and a purchase index.

4. The method of claim 1, wherein the propensity-to-purchase value is generated by performing statistical modeling operations.

5. The method of claim 4, wherein the statistical modeling operations are performed using input data comprising at least one of:
a set of media response variables;
a set of promotion variables;
a set of revenue variables;
a set of firmographics data; and
a site visit index.

6. The method of claim 5, wherein the at least one site visit index is generated using a set of purchase variables as input data.

7. A system comprising:
a processor;
a data bus coupled to the processor; and
a computer-usable medium embodying computer program code, the computer-usable medium being coupled to the data bus, the computer program code interacting with a plurality of computer operations and comprising instructions executable by the processor and configured for:
processing a first set of social media interaction data to generate a second set of social media interaction data containing a reference to an intent to purchase a product, the first set of social media interaction data associated with a first set of social media users and the second set of social media interaction data associated with a second set of set of social media users;
processing a third set of social media interaction data with the prioritization index to generate a propensity-to-purchase value for individual users of a third set of social media users, the third set of social media interaction data associated with the third set of social media users; and
performing ranking operations to rank the second set of social media users according to their respective propensity-to-purchase value.

8. The system of claim 7, wherein the second set of social media interaction data is generated by performing Natural Language Processing (NLP) operations.

9. The system of claim 7, wherein the prioritization index is generated from a site visit index and a purchase index.

10. The system of claim 7, wherein the propensity-to-purchase value is generated by performing logic statistical modeling operations.

11. The system of claim 10, wherein the statistical modeling operations are performed using input data comprising at least one of:
a set of media response variables;
a set of promotion variables;
a set of revenue variables;
a set of firmographics data;
a site visit index.

12. The system of claim 11, wherein the at least one site visit index is generated using a set of purchase variables as input data.

13. A computer-usable medium embodying computer program code, the computer program code comprising computer executable instructions configured for:
processing a first set of social media interaction data to generate a second set of social media interaction data containing a reference to an intent to purchase a product, the first set of social media interaction data associated with a first set of social media users and the second set of social media interaction data associated with a second set of set of social media users;
processing the second set of social media interaction data to generate a prioritization index;
processing a third set of social media interaction data with the prioritization index to generate a propensity-to-purchase value for individual users of a third set of social media users, the third set of social media interaction data associated with the third set of social media users; and
performing ranking operations to rank the third set of social media users according to their respective propensity-to-purchase value.

14. The computer usable medium of claim 13, wherein the second set of social media interaction data is generated by performing Natural Language Processing (NLP) operations.

15. The computer usable medium of claim 13, wherein the prioritization index is generated from a site visit index and a purchase index.

16. The computer usable medium of claim 13, wherein the propensity-to-purchase value is generated by performing statistical modeling operations.

17. The computer usable medium of claim 16, wherein the statistical modeling operations are performed using input data comprising at least one of:
a set of media response variables;
a set of promotion variables;
a set of revenue variables;
a set of firmographics data; and
a site visit index.

18. The computer usable medium of claim 17, wherein the at least one site visit index is generated using a set of purchase variables as input data.

19. The computer usable medium of claim 13, wherein the computer executable instructions are deployable to a client computer from a server at a remote location.

20. The computer usable medium of claim 13, wherein the computer executable instructions are provided by a service provider to a customer on an on-demand basis.
